(19) United States
(12) Patent Application Publication
(10) Pub. No.: US 2026/0328453 A1
(43) Pub. Date: Oct. 22, 2026

(54) MULTI-CHANNEL REFRIGERANT LEAKAGE DETECTOR

(71) Applicant: JIANGSU JINGCHUANG ELECTRONICS CO., LTD., Xuzhou City (CN)

(72) Inventors: Chong LIN, Xuzhou City (CN); Shuangyun LI, Xuzhou City (CN); Shunzai BIAN, Xuzhou City (CN); Lianghui PAN, Xuzhou City (CN)

(21) Appl. No.: 19/651,597

(22) Filed: Apr. 17, 2026

(30) Foreign Application Priority Data
Apr. 18, 2025 (CN) 2025104892491

(51) Int. Cl. F25B 49/00; G01M 3/38

(52) U.S. Cl. CPC F25B 49/005; G01M 3/38; F25B 2500/222

(57) ABSTRACT

A multi-channel refrigerant leakage detector includes a gas inlet, a gas outlet, and a gas absorption chamber arranged between the gas inlet and the gas outlet. An infrared blackbody light source and a multi-channel infrared detector are respectively arranged at the gas inlet end and gas outlet ends of the gas absorption chamber. The multi-channel infrared detector includes at least two detection channels, an optical filter in each detection channel is configured for detecting a kind of refrigerant gas, the multi-channel infrared detector is connected to a control unit, and the control unit is configured to, during leakage detection of the gas at the gas inlet, gate the detection channel corresponding to the type of the refrigerant gas to be detected in the multi-channel infrared detector and generate a qualitative detection result based on the detection signal of the detection channel.

### CROSS REFERENCE TO RELATED APPLICATION

The present application claims benefit to Chinese Patent Application Serial no. 2025104892491, filed Apr. 18, 2025, the contents of which is incorporated herein.

### TECHNICAL FIELD

The preset application relates to the technical field of gas detection, and in particular to a multi-channel refrigerant leakage detector.

### BACKGROUND ART

Gas sniffer is a device for detecting and analyzing gas leakages, and is widely used in the fields including industries, environmental protection, and security. It can detect various gases, including but not limited to flammable gases, toxic gases, volatile organic compounds (VOCs), etc.

Among gas sniffers, infrared gas sniffers that use Non-Dispersive Infrared (NDIR) technology for gas detection are widely used in various gas detection scenarios due to their advantages of not directly contacting with gas and having a long service life.

In the prior art, when refrigerant leakage detection is to be performed on some devices, due to the difference of the types of the refrigerant gas, it is often necessary to replace the corresponding gas sniffer for detection or replace the detection sensor inside the gas sniffer according to the type of refrigerant to be detected, which is very inconvenient and not intelligent.

### CONTENTS OF THE INVENTION

In order to address shortcomings in the prior art, an object of the present application is to provide a multi-channel refrigerant leakage detector that can accurately detect the leakage of various refrigerants without the need of replacing sensors.

To achieve the above object, the present application provides a multi-channel refrigerant leakage detector, which comprises a gas inlet, a gas outlet, and a gas absorption chamber arranged between the gas inlet and the gas outlet; wherein, an infrared blackbody light source and a multi-channel infrared detector are respectively arranged at the gas inlet end and gas outlet end of the gas absorption chamber, the multi-channel infrared detector includes at least two detection channels, an optical filter in each detection channel of the multi-channel infrared detector is configured to be suitable for detecting a kind of refrigerant gas, the multi-channel infrared detector is connected to a control unit, and the control unit is configured to, during leakage detection of the gas at the gas inlet, gate the detection channel corresponding to the type of the refrigerant gas to be detected in the multi-channel infrared detector and generate a qualitative detection result based on the detection signal of the detection channel.

Furthermore, the multi-channel infrared detector includes at least two of the following detection channels:

A carbon dioxide detection channel configured to be suitable for detecting carbon dioxide gas;

A hydrocarbon refrigerant detection channel configured to be suitable for detecting at least one kind of hydrocarbon refrigerant gas; and

A halogen refrigerant detection channel configured to be suitable for detecting at least one kind of halogen refrigerant gas.

Furthermore, the multi-channel infrared detector further comprises a reference channel, and the control unit is further configured to, during leakage detection of the gas at the gas inlet, sequentially gate the reference channel and the detection channel corresponding to the type of the refrigerant gas to be detected of the multi-channel infrared detector and generate a qualitative detection result based on the detection signals of the reference channel and the detection channel.

Furthermore, a switch and a filtering and amplifying circuit are arranged between the multi-channel infrared detector and the control unit, wherein:

The switch is connected to the multi-channel infrared detector and the control unit, and configured to gate the channel of the multi-channel infrared detector for outputting detection signal;

The filtering and amplifying circuit is connected to the switch, and is configured to filter and amplify the detection signal and output it to the control unit.

Furthermore, it further comprises:

An acceleration sensor connected to the control unit and configured to detect the acceleration of the refrigerant leakage detector.

Furthermore, at least 80 % of the infrared light emitted from the infrared blackbody light source enters the gas absorption chamber, and after passing through the gas absorption chamber, at least 80 % of the infrared light is irradiated onto the infrared detector.

Furthermore, the infrared blackbody light source is configured to be driven by a constant power drive circuit.

Furthermore, the gas absorption chamber is enclosed by two shielding hoods.

Furthermore, it also comprises a Bluetooth module, and the Bluetooth module is connected to the control unit for transmitting the detection result through Bluetooth.

To achieve the above object, the present application also provides a method for detecting refrigerant leakage, which is applied to the above mentioned multi-channel refrigerant leakage detector, and the method comprises:

Gating the reference channel and the detection channel corresponding to the type of the gas to be detected of the multi-channel infrared detector in turn according to the type of the gas to be detected;

Generating a concentration of the gas to be detected based on the detection signal of the reference channel and the detection signal of the gated detection channel.

The multi-channel refrigerant leakage detector of the present application has a simple structure, can accurately detect leakage of various refrigerants without the need to replace sensors, has a high detection accuracy and strong anti-interference ability.

Other features and advantages of the present application will be set forth in the following description, and will partially become obvious from the description or understood by implementing the present application.

### DESCRIPTION OF DRAWINGS

The accompanying drawings are provided for further understanding of the present application, form a part of the description, and are used to explain the present application in conjunction with examples of the present application without constituting any limitation to the present application. In the drawings:

FIG. 1 is a schematic block diagram of the multi-channel refrigerant leakage detector in Example 1 of the present application;

FIG. 2 is a schematic structural diagram of the gas absorption chamber in Example 1 of the present application;

FIG. 3 is a schematic structural diagram of the constant power drive circuit in Example 1 of the present application; and

FIG. 4 is a schematic diagram of the changes in detection signals in various examples.

### DESCRIPTION OF REFERENCE NUMERALS

1 - first PCB board; 2 - infrared blackbody light source; 3 - side foam; 4 - first shielding hood; 5 - third PCB board; 6 - gas absorption chamber; 7 - bottom foam, 8 - second shielding hood; 9 - top foam; 10 - sealing ring; 11 - multi-channel infrared detector; 12 - second PCB board; 13 - screw, 14 - rear cover; 100 - control unit; 101 - power supply; 102 - switch, 103 - filtering and amplifying circuit; 104 - voltage reference unit; 105 - communication unit; 106 - constant power drive circuit; 107 - acceleration sensor.

### DETAILED DESCRIPTION OF EMBODIMENTS

Hereunder examples of the present application will be described in more detail with reference to the accompanying drawings. Although the drawings show some examples of the present application, it should be understood that the present application can be implemented in various forms and should not be interpreted to be limited to the examples set forth herein. On the contrary, these examples are provided for a thorough and full understanding of the present application. It should be understood that the accompanying drawings and the examples of the present application are simply for exemplary purposes and are not intended to limit the protection scope of the present application.

It should be understood that the various steps recorded in method embodiments of the present application can be carried out in different orders and/or carried out in parallel. In addition, the method embodiments can include additional steps and/or omit the shown steps. The scope of the present application is not limited in this aspect.

The term “including” and its variations as used herein refers to open-ended including, that is, “including but not limited to”. The term “based on” refers to “at least partially based on”. The term “an example” refers to “at least one example”. The term “another example” refers to “at least one another embodiment”. The term “some examples” refers to “at least some examples”. The related definitions of other terms will be given in the following description.

It should be noted that “a/an” and “a plurality of” mentioned in the present application are illustrative rather than restrictive, and those skilled in the art should understand that, unless otherwise explicitly stated in the context, these words should be understood as “one or more”. “More” should be understood as two or more.

Hydrocarbon refrigerant: the hydrocarbon refrigerant refers to a natural refrigerant with the hydrocarbons, such as propane (R290), isobutane (R600A) and propylene (R1270), as the main components. Such kind of refrigerant has attracted much attention in recent years due to its excellent environmental characteristics: its ozone depletion potential (ODP) is zero, and its global warming potential (GWP) is extremely low (such as R290’s GWP is only 3, far lower than the traditional refrigerant R410A’s 2088), fully meeting the requirements of international environmental regulations for reducing greenhouse gas emissions. In addition, hydrocarbon refrigerants have excellent thermodynamic properties and high coefficient of performance (COP), can significantly reduce system energy consumption and are suitable for household refrigerators, small air conditioners, and commercial refrigeration equipment. However, its highly flammable and explosive characteristics (such as R290 has an explosion limit of 2.1% to 9.5%) impose strict requirements on the safety design. The equipment must adopt explosion-proof electrical elements and a strict seal process, and limit the filling amount (such as the IEC standard stipulates that the filling amount of household refrigerators should not exceed 150 grams). Despite safety challenges, hydrocarbon refrigerants have been widely used in Europe, India, and other regions, and have been gradually expanded to the fields of cold chain logistics and heat pumps with technological progress.

Halogen refrigerant: the halogen refrigerant refers to a class of compounds containing halogen elements such as fluorine, chlorine and bromine, etc, which was once widely used in refrigeration and air conditioning systems. Such refrigerant mainly includes chlorofluorocarbons (CFCs), hydrochlorofluorocarbons (HCFCs), and hydrofluorocarbons (HFCs) etc. Among them, R22 (difluorochloromethane) is one of the most common halogen refrigerants with good refrigeration performance, which is however being gradually replaced according to the relevant provisions of the Montreal Protocol due to due to its high ozone depletion potential. R134a (tetrafluoroethane) is also an important halogen refrigerant with low ozone depletion potential, but it has a higher global warming potential. The working principle of halogen refrigerants is to take advantage of their phase change characteristics at different temperatures and pressures to achieve heat absorption and release, thereby achieving refrigeration effects. The halogen refrigerants are cyclically used in the refrigeration system, completing the refrigeration cycle through the collaborative work of components such as compressors, condensers, expansion valves, and evaporators. The halogen refrigerants are not limited to the application in air conditioners and refrigerators, they can also be applied in various fields such as industrial refrigeration equipment, commercial refrigeration equipment and automotive air conditioning systems etc. However, due to their potential harm to the environment, many countries and regions are working to reduce the use of halogen refrigerants and promote more environmentally friendly alternatives.

Hereunder examples of the present application will be described in detail with reference to the accompanying drawings.

### Example 1

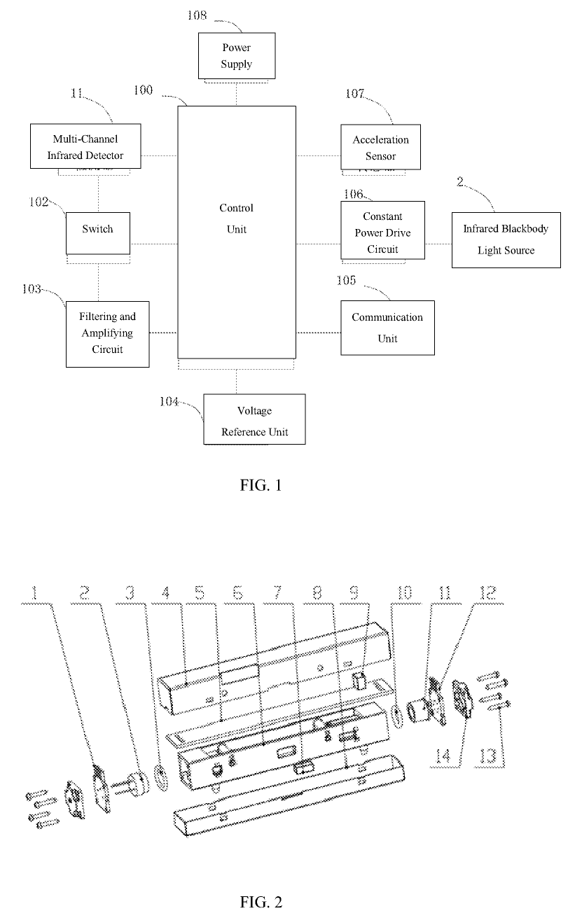

An example of the present application provides a multi-channel refrigerant leakage detector that can accurately detect the leakage of various refrigerants without the need to replace sensors. Hereunder the multi-channel refrigerant leakage detector of the present application will be described in detail with reference to FIGS. 1-3, and the multi-channel refrigerant leakage detector comprises:

A gas inlet, a gas outlet, and a gas absorption chamber 6 arranged between the gas inlet and the gas outlet, an infrared blackbody light source 2 and a multi-channel infrared detector 11 are respectively arranged at the gas inlet end and the gas outlet end of the gas absorption chamber 6.

In this embodiment, the multi-channel infrared detector 11 is an infrared detector with three channels, and the three detection channels include a carbon dioxide detection channel, a hydrocarbon refrigerant detection channel, and a halogen refrigerant detection channel, wherein the carbon dioxide detection channel is configured to be suitable for detecting carbon dioxide gas, with a corresponding optical filter having a center wavelength of 4.26 μm and a bandwidth of 180nm; the hydrocarbon refrigerant detection channel is configured to detect two kinds of hydrocarbon refrigerants, R290 and R600A, with a corresponding optical filter having a center wavelength of 3.4 μm and a bandwidth of 120nm; the halogen refrigerant detection channel is configured to detect two kinds of halogen refrigerants, R12 and R22, with a corresponding optical filter having a center wavelength of 8.6 μm and a bandwidth of 150nm.

It can be understood that a gas pump can be also arranged between the gas inlet and the gas outlet of the multi-channel refrigerant leak detector to draw the gas to be detected into the absorption chamber through the gas inlet.

In some other examples, the center wavelength and the bandwidth of each optical filter may be adjusted before delivery according to the detection accuracy and the center wavelength of the refrigerant expected to be detected.

It should be noted that the optical filter having a center wavelength of 3.4 μm and a bandwidth of 120nm used in the hydrocarbon refrigerant detection channel in this embodiment can accurately detect both R290 refrigerant and R600A refrigerant, because the center wavelengths of R290 and R600A are both 3.4 μm.

The multi-channel infrared detector 11 is connected to a control unit 100, and the control unit 100 is configured to, during leakage detection of the gas at the gas inlet, gate the detection channel corresponding to the type of the refrigerant gas to be detected in the multi-channel infrared detector 11 and generate a detection result based on the detection signal of the detection channel.

It can be understood that the detection result in this example of the present application is a qualitative detection result, namely, a detection result whether there is refrigerant at the gas inlet of the refrigerant leakage detector is judged and given based on the change of the detection signal: when the change of the detection signal meets the set change threshold, which is obtained and set through tests before delivery, it is considered that there is a leakage.

It can be understood that the detection signal in examples of the present application refers to the light intensity signal detected by the multi-channel infrared detector 11.

In this embodiment, a switch 102 and a filtering and amplifying circuit 103 are arranged between the multi-channel infrared detector 11 and the control unit 100, wherein:

The switch 102 is connected to the multi-channel infrared detector 11 and the control unit 100, and configured to gate the channel of the multi-channel infrared detector 11 for outputting detection signal;

The filtering and amplifying circuit 103 is connected to the switch 102 and is configured to filter and amplify the detection signal and output it to the control unit 100.

An acceleration sensor 107 is connected to the control unit 100 and configured to detect the acceleration of the refrigerant leakage detector, judge and detect abnormal gesture operation in real time, determine the validity of the detection signal, reduce the risk of false alarm, and achieve a more accurate and intelligent detection. According to ergonomics and instrument operation requirements, the acceleration in normal use is between 0.5 to 2 m/s², and there is a certain probability of false alarm if the acceleration is greater than 3.5 m/s². Thus, when the acceleration is detected to be greater than 3.5m/s², the detection signal is not considered valid and no detection result is generated.

In this embodiment, at least 80 % of the infrared light emitted from the infrared blackbody light source 2 enters the gas absorption chamber 6 by adjusting the emitting angle of the infrared blackbody light source 2 and the distance between the infrared blackbody light source 2 and the gas absorption chamber 6. At least 80 % of the infrared light, after passing through the gas absorption chamber 6, is irradiated onto the multi-channel infrared detector 11 to ensure detection accuracy.

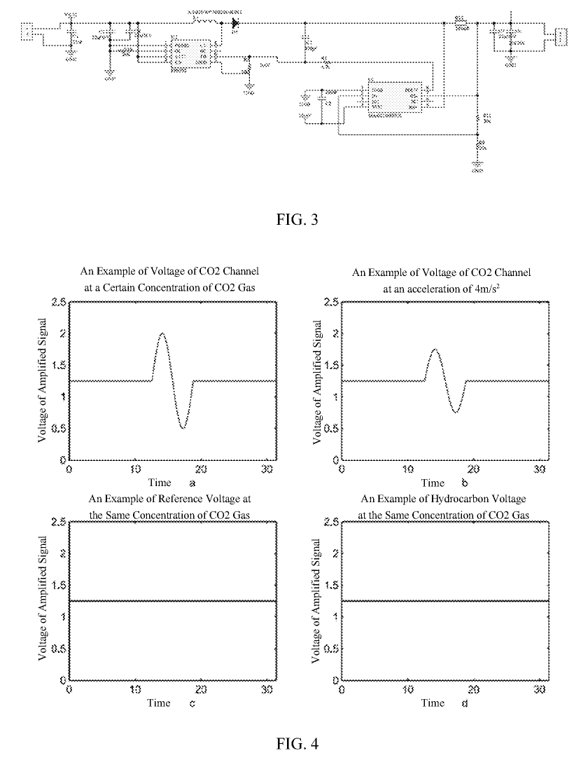

In this embodiment, the infrared blackbody light source 2 is configured to be driven by a constant power drive circuit 106. FIG. 3 is a schematic structural diagram of a constant power drive circuit for the infrared blackbody light source. As shown in FIG. 3, the constant power drive circuit 106 includes:

A FP6298 type DC-DC chip U2, including an EN terminal, a PGND terminal, an OC terminal, a VCC terminal, an LX terminal, an NC terminal, an FB terminal, and a GND terminal, wherein, the PGND terminal (input power ground) is connected to the power node VBAT through the seventh capacitor C7; the PGND terminal (input power ground) is also connected to the GND node; the OC terminal (overcurrent protection terminal) is connected to the GND node through the tenth resistor R10; the VCC terminal is connected to the power node VBAT; the EN terminal (enable terminal) is connected to the power node VBAT and controlled by the control unit; the LX terminal (switch MOS terminal) is connected to the positive terminal of the first diode D1, and the negative terminal of the first diode D1 is connected to the FB terminal (feedback input terminal) through the third capacitor C3; the NC terminal is not connected; the FB terminal is grounded through a sampling resistor R2; the GND terminal (output ground terminal) is connected to the GND node.

The first capacitor C1 arranged between the power node VBAT and the GND node.

The fourth capacitor C4 arranged in parallel at both ends of the seventh capacitor C7.

The first inductor L1 arranged between the power node VBAT and the positive electrode of the first diode D1.

A MAX421 type monitoring chip U1, including a GND terminal, an IN terminal, two NC terminals, a VCC terminal, a POUT terminal, an RS- terminal, and an RS+ terminal, wherein the GND terminal is connected to the GND node; the VCC terminal is connected to the power node VBAT; a second capacitor C2 is also arranged between the GND terminal and the VCC terminal; the IN terminal is connected to the GND node through a ninth capacitor C9; the POUT terminal is connected to the FB terminal of the DC-DC chip through the first resistor R1; the RS- terminal is connected to the GND node through an eleventh resistor R11 and a ninth resistor R9; and the RS+ terminal is connected to the negative electrode of the first diode D1.

The 35th resistor R35, two terminals of which are respectively connected to the negative electrode of the first diode D1 and the light source voltage node P_5V, wherein the light source voltage node P_5V is also connected to the RS- terminal, and a fifth capacitor C5 and a sixth capacitor C6 are also connected in parallel between the light source voltage node P_5V and the GND node.

The working principle of the constant power drive circuit 106 is as follows:

The control unit enables the EN pin of the DC-DC chip, when the EN pin is set high, the sixth resistor R6 and the twelfth capacitor C12 realize RC filtering so that the signal is smoother and the voltage at the output terminal is correspondingly smoother. At the same time, a sampling resistor R2 is used to detect the current flowing through the infrared blackbody light source 2, and if the current is too high, feedback regulation is carried out through the monitoring chip MAX4210, wherein the Upout becomes larger, causing the voltage at the FB pin of the DC-DC chip to be higher, so as to decrease the voltage of the output terminal of the DC-DC chip. If the current detected by the sampling resistor R2 is small, the Upout voltage of the monitoring chip will be decreased, causing the voltage at the FB pin of the DC-DC chip to be decreased, so that the DC-DC chip outputs a larger voltage to maintain the power of the light source. In addition, the control unit 100 is used to detect the Upout voltage signal. If the signal is abnormal, the microcontroller unit switches the EN pin at the enable terminal, the DC-DC chip stops supplying power to the light source, protecting the infrared blackbody light source 2.

In this embodiment, the constant power drive circuit 106 incorporates soft start to avoid supply voltage oscillations at the power-on moment. Additionally, RC resistance-capacitance filtering is added to prevent damage to the infrared blackbody light source 2 caused by peak current.

In some other embodiments, the constant power drive circuit 106 can also be other constant power drive circuits provided with RC resistance-capacitance filtering and soft start to ensure stable operation of the infrared blackbody light source.

It can be understood that pulse width modulation technology can be used to control the brightness of the infrared blackbody light source.

In this embodiment, a power supply 108 and a voltage reference unit 104 are also arranged to provide power and reference voltage to the control unit.

In this embodiment, two ends of the gas absorption chamber 6 are respectively provided with a front cover and a rear cover 14, wherein a first PCB board 1 is arranged on the front cover, the infrared blackbody light source 2 and the constant power drive circuit 106 are arranged on the first PCB board 1, a second PCB board 12 is arranged on the rear cover 14, the multi-channel infrared detector 11 is arranged on the second PCB board 12, a third PCB board 5 is arranged on the upper portion of the gas absorption chamber 6, the control unit 100 is arranged on the third PCB board 5, the first PCB board 1 and the second PCB board 12 are both connected to the third PCB board 5, and the front cover and the rear cover 14 are fixed with screws 13.

In this embodiment, the gas absorption chamber 6 is enclosed by the first shielding hood 4 and the second shielding hood 8.

In this embodiment, a top foam 9 is arranged between the gas absorption chamber 6 and the first shielding hood 4, a side foam 3 is arranged between the gas absorption chamber 6 and the infrared blackbody light source 2, a bottom foam 7 is arranged between the gas absorption chamber 6 and the second shielding hood 8, and a sealing ring 10 is arranged between the gas absorption chamber 6 and the infrared detector 11.

In this embodiment, a communication unit 105, that is a Bluetooth module, is also provided, and the Bluetooth module is connected to the control unit 100 for transmitting the detection result through Bluetooth.

In some other embodiments, the communication unit 105 may also utilize other wired or wireless communication modules to transmit the detection result to other terminals for users to view the detection result.

It can be understood that the Bluetooth module can connect to an APP in the mobile device, not only preparing for subsequent product upgrades, but also saving detection data during user use, which makes the product more intelligent and convenient.

A detection method in an example of the present application is as follows:

When the refrigerant leakage detector is used to detect various points where carbon dioxide refrigerant leakage may occur, the refrigerant leakage detector is first turned on, energized and warmed up for 30 seconds. At the same time, the gas pump and the infrared blackbody light source are turned on; acceleration signal is read in real time; the carbon dioxide detection channel of the multi-channel infrared detector is gated under control, the detection signal of the carbon dioxide detection channel is acquired in real time, filtered and amplified with the filtering and amplifying circuit, and output to the control unit. The gas inlet of the refrigerant leakage detector is aligned with each point one by one and the control unit determines whether there is carbon dioxide leakage at each point based on the changes of the real-time detection signal and provides a detection result whether there is a leakage.

### Example 2

An example of the present application provides a multi-channel refrigerant leakage detector that accurately detects leakages of various refrigerants without the need to replace sensor. The Example 2 of the present application is different from Example 1 in that:

In this embodiment, the multi-channel infrared detector 11 is an infrared detector with four channels, and the four channels include a reference channel, a carbon dioxide detection channel, a hydrocarbon refrigerant detection channel, and a halogen refrigerant detection channel, wherein the carbon dioxide detection channel is configured to be suitable for detecting carbon dioxide gas, with a corresponding optical filter having a center wavelength of 4.26 μm and a bandwidth of 180 nm; the hydrocarbon refrigerant detection channel is configured to detect two kinds of hydrocarbon refrigerants, R290 and R600A, with a corresponding optical filter having a center wavelength of 3.4 μm and a bandwidth of 120 nm; the halogen refrigerant detection channel is configured to detect two kinds of halogen refrigerants, R12 and R22, with a corresponding optical filter having a center wavelength of 8.6 μm and a bandwidth of 150 nm; and the corresponding optical filter in the reference channel has a center wavelength of 3.95 μm and a bandwidth of 91 nm.

In this embodiment, the control unit 100 is further configured to, during leakage detection of the gas at the gas inlet, gate the reference channel and the detection channel corresponding to the type of refrigerant gas to be detected of the multi-channel infrared detector in turn, and generate a quantitative detection result based on the detection signals of the reference channel and the detection channel.

In this embodiment, due to the different absorbed light intensities in different bands, the control unit 100 can also assess the leakage extent of the refrigerant gas based on the quantitative detection result, which is the ratio of the detection signal of the gated detection channel to the detection signal of the reference channel.

In some other embodiments, the relationship expression between the detection signals of each detection channel and the reference channel and the concentration of the refrigerant to be detected can be experimentally fitted before delivery, so that the concentration value of the refrigerant to be detected is generated as the detection result with the relationship expression based on the detection signal of the reference channel and the detection signal of the gated detection channel that are detected in real time.

Referring to FIG. 4, where FIG. 4a shows the changes of the detection signal of the carbon dioxide detection channel when the carbon dioxide with a certain concentration is the gas to be detected; FIG. 4b shows a schematic diagram of the changes of the detection signal of the carbon dioxide detection channel when the acceleration is 4m/s²; FIG. 4c shows a schematic diagram of the changes of the detection signal of the reference channel when the carbon dioxide with the same concentration is the gas to be detected.

FIG. 4d shows a schematic diagram of the changes of the detection signal of the hydrocarbon refrigerant detection channel when carbon dioxide with the same concentration is used as the gas to be detected; as can be seen from FIGS. 4a and 4b, without introducing the gas to be detected, the carbon dioxide detection channel can generate detection signal similar to that in FIG. 4a only when the acceleration is 4m/s², thus it is necessary to detect the acceleration of the refrigerant leakage detector, so as not to deem the detected detection signal as valid in case that the acceleration is greater than 3.5m/s² and not to generate the detection result.

The examples of the present application provide a detection method as follows:

When the refrigerant leakage detector is used to detect various points where carbon dioxide refrigerant leakage may occur, the refrigerant leakage detector is first turned on, energized and warmed up for 30 seconds. The gas pump is turned on and pulse-width modulation is performed to the infrared blackbody light source; an acceleration signal is read in real time; and then the gas inlet of the refrigerant leakage detector is aligned with each point one by one for detection. When detection is made to each point, the reference channel and the carbon dioxide detection channel of the multi-channel infrared detector are gated in turn under control and the circuit board analog switch is electronically switched. The detection signals are acquired, filtered and amplified with the filtering and amplifying circuit, and output into the control unit for processing. The control unit generates a quantitative detection result for the point based on the ratio of the detection signal of the gated carbon dioxide channel to the detection signal of the reference channel.

The above description only illustrate some examples of the present application and the technical principles applied therein. Those skilled in the art should understand that the scope of the disclosure involved in the present application is not limited to the technical solutions formed by the specific combination of the above technical features, but also should cover other technical solutions formed by any combination of the above technical features or their equivalent features without departing from the above disclosed concept, for example, a technical solution formed by substituting the above-mentioned features with (but not limited to) the technical features having similar functions disclosed in the present application.

Moreover, although various operations are described in a specific order, it should not be interpreted as requiring these operations to be performed in the indicated specific order or in a sequential order. Under certain circumstances, multitasking and parallel processing may be beneficial. Similarly, although the above discussion includes several implementation details, these should not be interpreted as limitations on the scope of the present application. Some features described in the context of a single example may also be combined to be implemented in a single example. On the contrary, various features described in the context of a single example can also be implemented separately or in any appropriate sub-combination in multiple examples.

Although the subject matter has been described in language specific to structural features and/or method logical actions, it should be understood that the subject matter defined in the appended claims is not necessarily limited to the specific features or actions described above. On the contrary, the specific features and actions described above are merely examples for implementing the claims.

1. A multi-channel refrigerant leakage detector, comprising, a gas inlet, a gas outlet, and a gas absorption chamber arranged between the gas inlet and the gas outlet; an infrared blackbody light source and a multi-channel infrared detector are respectively arranged at the gas inlet end and gas outlet end of the gas absorption chamber, wherein the multi-channel infrared detector includes at least two detection channels, wherein an optical filter in each detection channel of the multi-channel infrared detector is configured to be suitable for detecting a kind of refrigerant gas, wherein the multi-channel infrared detector is connected to a control unit, and the control unit is configured to, during leakage detection of the gas at the gas inlet, gate the detection channel corresponding to the type of the refrigerant gas to be detected in the multi-channel infrared detector and generate a qualitative detection result based on the detection signal of the detection channel.

2. The multi-channel refrigerant leakage detector according to claim 1, wherein the multi-channel infrared detector includes at least two of the following detection channels:
a carbon dioxide detection channel configured for detecting carbon dioxide gas;
a hydrocarbon refrigerant detection channel configured for detecting at least one kind of hydrocarbon refrigerant gas; and
a halogen refrigerant detection channel configured for detecting at least one kind of halogen refrigerant gas.

3. The multi-channel refrigerant leakage detector according to claim 1, wherein the multi-channel infrared detector further comprises a reference channel, and the control unit is further configured to, during leakage detection of the gas at the gas inlet, gate the reference channel and the detection channel corresponding to the type of the refrigerant gas to be detected of the multi-channel infrared detector in turn and generate a qualitative detection result based on the detection signals of the reference channel and the detection channel.

4. The multi-channel refrigerant leakage detector according to claim 1, wherein a switch and a filtering and amplifying circuit are arranged between the multi-channel infrared detector and the control unit, wherein:
the switch is connected to the multi-channel infrared detector and the control unit and configured to gate the channel of the multi-channel infrared detector for outputting detection signal; and
the filtering and amplifying circuit is connected to the switch and is configured to filter and amplify the detection signal and output it to the control unit.

5. The multi-channel refrigerant leakage detector according to claim 1, further comprising:
an acceleration sensor connected to the control unit and configured to detect acceleration of the refrigerant leakage detector.

6. The multi-channel refrigerant leakage detector according to claim 1, wherein at least 80% of the infrared light emitted from the infrared blackbody light source enters the gas absorption chamber, and after passing through the gas absorption chamber, at least 80% of the infrared light is irradiated onto the infrared detector.

7. The multi-channel refrigerant leakage detector according to claim 1, wherein the infrared blackbody light source is configured to be driven by a constant power drive circuit.

8. The multi-channel refrigerant leakage detector according to claim 1, wherein the gas absorption chamber is enclosed by two shielding hoods.

9. The multi-channel refrigerant leakage detector according to claim 1, further comprising a Bluetooth module, which is connected to the control unit for transmitting the detection result through Bluetooth.

10. A method for detecting refrigerant leakage, which is applied to the multi-channel refrigerant leakage detector according to claim 1, wherein the method comprises:
gating the reference channel and the detection channel corresponding to the type of the gas to be detected of the multi-channel infrared detector in turn according to the type of the gas to be detected; and
generating the concentration of the gas to be detected based on the detection signal of the reference channel and the detection signal of the gated detection channel.

11. A method for detecting refrigerant leakage, which is applied to the multi-channel refrigerant leakage detector according to claim 2, wherein the method comprises:
gating the reference channel and the detection channel corresponding to the type of the gas to be detected of the multi-channel infrared detector in turn according to the type of the gas to be detected; and
generating the concentration of the gas to be detected based on the detection signal of the reference channel and the detection signal of the gated detection channel.

12. A method for detecting refrigerant leakage, which is applied to the multi-channel refrigerant leakage detector according to claim 3, wherein the method comprises:
gating the reference channel and the detection channel corresponding to the type of the gas to be detected of the multi-channel infrared detector in turn according to the type of the gas to be detected; and
generating the concentration of the gas to be detected based on the detection signal of the reference channel and the detection signal of the gated detection channel.

13. A method for detecting refrigerant leakage, which is applied to the multi-channel refrigerant leakage detector according to claim 4, wherein the method comprises:
gating the reference channel and the detection channel corresponding to the type of the gas to be detected of the multi-channel infrared detector in turn according to the type of the gas to be detected; and
generating the concentration of the gas to be detected based on the detection signal of the reference channel and the detection signal of the gated detection channel.

14. A method for detecting refrigerant leakage, which is applied to the multi-channel refrigerant leakage detector according to claim 5, wherein the method comprises:
gating the reference channel and the detection channel corresponding to the type of the gas to be detected of the multi-channel infrared detector in turn according to the type of the gas to be detected; and
generating the concentration of the gas to be detected based on the detection signal of the reference channel and the detection signal of the gated detection channel.

15. A method for detecting refrigerant leakage, which is applied to the multi-channel refrigerant leakage detector according to claim 6, wherein the method comprises:
gating the reference channel and the detection channel corresponding to the type of the gas to be detected of the multi-channel infrared detector in turn according to the type of the gas to be detected; and
generating the concentration of the gas to be detected based on the detection signal of the reference channel and the detection signal of the gated detection channel.

16. A method for detecting refrigerant leakage, which is applied to the multi-channel refrigerant leakage detector according to claim 7, wherein the method comprises:
gating the reference channel and the detection channel corresponding to the type of the gas to be detected of the multi-channel infrared detector in turn according to the type of the gas to be detected; and
generating the concentration of the gas to be detected based on the detection signal of the reference channel and the detection signal of the gated detection channel.

17. A method for detecting refrigerant leakage, which is applied to the multi-channel refrigerant leakage detector according to claim 8, wherein the method comprises:
gating the reference channel and the detection channel corresponding to the type of the gas to be detected of the multi-channel infrared detector in turn according to the type of the gas to be detected; and
generating the concentration of the gas to be detected based on the detection signal of the reference channel and the detection signal of the gated detection channel.

18. A method for detecting refrigerant leakage, which is applied to the multi-channel refrigerant leakage detector according to claim 9, wherein the method comprises:
gating the reference channel and the detection channel corresponding to the type of the gas to be detected of the multi-channel infrared detector in turn according to the type of the gas to be detected; and
generating the concentration of the gas to be detected based on the detection signal of the reference channel and the detection signal of the gated detection channel.
